(19) United States
(12) Patent Application Publication
(10) Pub. No.: US 2020/0143004 A1
(43) Pub. Date: May 7, 2020

(54) VISUALIZATION OF MACHINE STRUCTURE DAMAGE FROM MACHINE SENSOR DATA USING MACHINE LEARNING

(71) Applicant: Caterpillar Inc.

(72) Inventors: VamsiKrishna Pateel, Oro Valley, AZ (US); Khaldoon N. Altahhan, Champaign, IL (US)

(73) Assignee: Caterpillar Inc., Deerfield, IL (US)

(21) Appl. No.: 16/178,192

(22) Filed: Nov. 1, 2018

(51) Int. Cl. G06F 17/50; G06N 99/00; G06N 7/00; G06K 9/62

(52) U.S. Cl. CPC G06F 17/5009; G06K 9/6269; G06N 7/00; G06N 99/005

(57) ABSTRACT

A non-transitory computer-readable storage medium storing a set of instructions that, when executed by a processor of a machine, cause the machine to perform operations including receiving first data indicative of an operating state of one or more test machines, receiving second data indicative of physical damage to first regions of the one or more test machines; generating a predictive data structure by iteratively correlating the first data with the second data; determine, based on one or more machine sensors, an operating state the field machine; determining physical damage to at least one region of the field machine; and generating, based on the physical damage to the at least one region of the frame of the field machine, a graphical display of the field machine including an image of the frame of the field machine and one or more indicators of theoretical damage to second regions of the field machine.

### TECHNICAL FIELD

This document pertains generally, but not by way of limitation, to detecting machine structure damage, and more particularly, to generating visual representations of damage to the structure of a machine.

### BACKGROUND

Large off-highway machines, such as trucks, excavators, and loaders, can operate in environments where they are subjected to severe loading events. Such loading conditions can arise from the heavy loads manipulated by these machines, maneuvering these machines over unimproved or uneven roadways, or various combinations of the conditions experienced in construction, mining, and other environments or work sites where these machines are typically used. Over time, the stresses generated by these loading events can torque, stress, or otherwise damage the frames of these machines, which can ultimately lead to failure of one or more machine components. Detecting and visualizing such frame damage can be useful for predicting frame or component failure, such as for determining required machine maintenance or potential interruptions to the productivity of a work site due to unavailability of one of these machines.

Techniques for detecting frame damage in large off-highway machines can require the installation of sensors, such as to measure strain or stress, at one or more locations in, or on, the frame of such machines. In an example, U.S. Pat. Pub. No. 2018/0089345A1 (hereinafter, the '345 application) provides a visualization system for visualizing structural integrity of a frame. The visualization system can include a monitoring device having one or more sensors coupled to the frame, and a workstation in communication with the one or more sensors. The sensors can be configured to measure field damage data. The workstation can include a display device, an analytical model database storing model damage data, and a controller. The controller can be configured to receive the field damage data from the sensors, receive the model damage data from the analytical model database, generate an events log based on the field damage data and the model damage data, map the model damage data to a visual model of the frame based on the events log, and display the visual model of the frame on the display device.

Because the solution presented in the '345 patent requires the installation of specific sensors, such as strain sensors, to measure frame damage, such a solution can be limited to machines that are specially configured with such as sensors. Such configuring can include substantial costs in terms operator/technician hours and sensing or monitoring technology. Consequently, it may not be financially or technologically feasible implement the solution disclosed in the '345 patent on an entire fleet of machines at a given worksite. Accordingly, there is a need for a technological solution for detecting and visualizing frame damage of large off-highway machines that does not require the installation of additional sensors, such as sensors that are not normally provided on such machines, on the frame or structure of such vehicles. More specifically, there is a need for improved frame or machine structure monitoring, prognostic, and diagnostic systems for off highway machines that do not require sensor or strain gauge placement on such machines.

### SUMMARY OF THE INVENTION

Embodiments of the present disclosure include a system for characterizing frame damage to a field machine. The system can include one or more processing circuits configured to receive first data indicative of an operating state of one or more test machines, and to receive second data indicative of physical damage to first regions of the one or more test machines, where at least part of the second data is captured contemporaneously with at least part of the first data. The one or more processing circuits can be further configured to generate, using the first data and the second data, a predictive data structure by iteratively correlating the operating state indicated by the first data with the physical damage indicated by the second data. The one or more processing circuits can also be configured to determine, based on one or more machine sensors, an operating state the field machine. The one or more processing circuits can also be configured to determine, using the predictive data structure and the operating state of the field machine, physical damage to at least one region of the field machine corresponding to at least one region of the first regions of the one or more test machines. The one or more processing circuits can be further configured generate, based on the physical damage to at least one region of the field machine, a graphical display of the field machine, where the graphical display comprises an image of the frame of the field machine and one or more indicators of theoretical damage to second regions of the machine.

Embodiments of the present disclosure include a method for visualizing damage to a frame of a field machine. The method can include receiving a data structure configured to predict physical damage to regions of the frame based on data indicative of an operating state of the field machine. The method can also include determining, based on one or more machine sensors, the operating state of the field machine. The method can also include predicting, using the data structure and the operating state of the field machine, physical damage to one or more first regions of the frame. The method can further include determining, using theoretical damage data and the predicted physical damage to the one or more first regions of the frame, physical damage to other regions of the frame. The method can further include generating a graphical display of the frame, where the graphical display comprises an image of the frame and damage indicators indicating the physical damage to the other regions of the frame.

Embodiments of the present disclosure include a non-transitory computer-readable storage medium storing a set of instructions that, when executed by at least one processor of a machine, cause the machine to perform operations including receiving first data indicative of an operating state of one or more test machines. The operations can also include receiving second data indicative of physical damage to first regions of the one or more test machines, where at least part of the second data is captured contemporaneously with at least part of the first data. The operations can further include generating, using the first data and the second data, a predictive data structure by iteratively correlating the first data with the second data. The operations can also include determining, using one or more machine sensors, an operating state a field machine. The operations can additionally include determining, using the predictive data structure and the operating state of the field machine, physical damage to at least one region of the field machine, where the at least one region of the field machine corresponds to at least one region of the first regions of the one or more test machines.

### BRIEF DESCRIPTION OF THE DRAWINGS

FIG. 1 illustrates a diagram an example of a system for visualizing machine frame damage using machine sensor data and machine learning, according to various embodiments.

FIG. 2 illustrates a diagram of an example of a system for using machine sensor data and machine learning to adaptively generate a damage prediction model for visualizing frame damage, according to various embodiments.

FIG. 3 illustrates an example of a process for predicting machine frame damage using machine sensor data and machine learning.

FIG. 4 illustrates an example of a process for visualizing machine frame damage predicted using machine sensor data and machine learning, according to various embodiments.

FIG. 5 illustrates an example of a visual representation of machine frame damage predicted using machine sensor data and machine learning.

### DETAILED DESCRIPTION

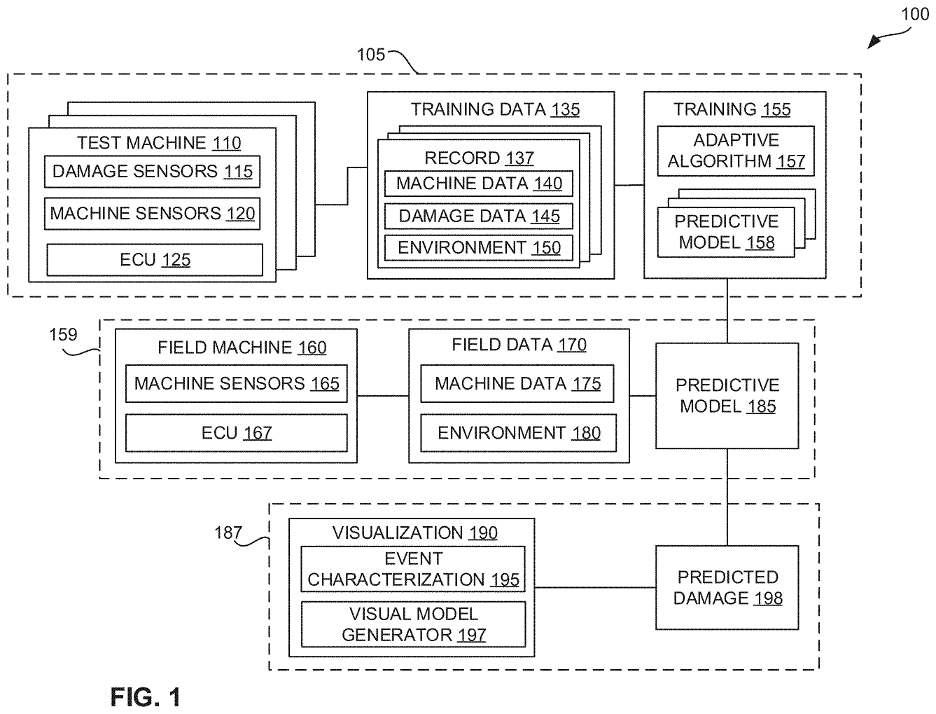

FIG. 1 illustrates a diagram an example of a system 100 for visualizing machine frame damage using machine sensor data and machine learning, according to various embodiments. One or more components of the system 100 can be included in a machine diagnostic system, such as to monitor the frame or machine structure (hereinafter, “the frame”) of one or more machines in real time or at specified intervals, such as to predict, visualize, or diagnose physical damage to the frame of such machines. The components or subcomponents of the system 100 can include software applications or hardware devices, such as electrical circuits, computing devices, storage devices, or sensors. Such components or subcomponents can communicate with each other, or with other software application or hardware devices, using any appropriate communication technique, such as by using a data communication network, a physical communication bus, or various inter-process communication techniques. The system 100 can include a machine learning component 105, a predictive component 159, and a visualization system 187.

The machine learning component 105 can include test machine 110, training data repository 135, and training component 155. Such components can include, or can be embodied within, one or more computing devices, such as a personal computer, a workstation, or an embedded hardware controller, such as an electronic control unit. Such computing devices can include hardware circuits, or software applications that are specially configured the execute, or implement, the operations of the machine learning component 105 and of the subcomponents thereof.

The test machine 110 can include one or more specially configured off-highway machines (hereinafter, “test machine” or “test machines”). A test machine can be configured, or instrumented, to have one or more damage sensors 115 that are disposed on, in, or proximate to, a frame of the test machine, such as to measure physical damage to specified locations, or regions, of the test machine. A test machine can also be configured with one or more machine sensors 120, such as sensors that are commonly integrated into a production machine to generate data indicative of the operating state of the production machine. A test machines can also include one or more computing devices, such as an electronic control unit (ECU) 125, that are coupled to the damage sensors 115 and to the machine sensors 120, such as to receive, or capture, damage data and machine sensor data that is generated, respectively, by these sensors. The ECU 125 can be configured with one or more data communication components, such as a wired network interface, wireless network interface, or a physical bus interface, to transmit, or to otherwise make available, the captured sensor data to one or more other computing systems or electronic data repositories.

The damage sensors 115 can include any optical, electrical, mechanical, chemical, or electro-mechanical, sensor that are configured to generate damage data that is indicative of physical damage to a test machine 110. Examples of such damage sensors 115 can include strain gauges, torsional sensors, load sensors, or stress sensors. Such damage sensors 115, for example, can generate data that is indicative of strain, torsional, load, or stress damage to the frame of a test machine 110. The damage sensors 115 can be placed at specific locations in, on, or proximate to, the frame of a test machine 110 to cause such sensors to generate data that is indicative of specific loading events experienced by the test machine or by another machine that is of the same class, series, model, or type as the test machine. The specific locations can be determined using test, simulation, or analytical, data that indicates specific locations on the frame of a machine that are damaged after the machine experiences of a specific loading event. Such data can be specific to a class, series, model, or type of the machine. Such data can also be specific to the work environment of the machine, such as the particular work site, the condition of the terrain at the work site, or the types of materials operated on at the work site. A loading event, or load mode, can include any event or operation that loads, or changes the distribution of the load on, a machine. Such events can include acquiring a load, traversing a slope, negotiating a corner, etc. The test, simulation, or analytical data can be analyzed to identify one or more specific locations of a frame that can experience physical damage which can characterize, or serve as a signature for identifying, a loading event that caused the damage. Accordingly, damage sensors 115 can be placed at these locations to capture damage data that is indicative of this characteristic damage.

The machine sensors 120 can include any optical, electrical, mechanical, chemical, or electro-mechanical sensor that is configured to generate machine data indicative of the operating state of a machine. Such sensors can include sensors that are normally installed on standard, or production, configurations of a machine of a specific class, series, model, or type. Such sensors can provide a machine operator with data indicating the operating state of the machine, such as in the form of machine speed, orientation, engine torque or speed, or any other data indicative of the operating state of condition of a machine.

In operation, the ECU 125 can sample data generated by one or more damage sensors 115 and one or more machine sensors 120 of a test machine 110 while the test machine performs a task in a specified environment. Such environments can be simulated using a physical testing site or a work site. Such environments can also be simulated using mechanical actuators in a test facility. In some embodiments, the ECU 125 can capture and store this data locally on one or more test machines 110, such as to enable an operator or other entity to manually retrieve the data at a later time. In other embodiments, the ECU 125 can capture and transmit this data, such a though a wireless communication channel, to a remote system for storage or analysis, such as for use by training component 155. The ECU 125 can capture and store data generated by both the damage sensors 115 and the machine sensors 120 at substantially the same time, such as to preserve the temporal correlations between the two datasets.

Training data component 135 can include an electronic data repository, such as a local storage device, database system, a distributed storage system, or any other computing system or device for storing electronic data. Such training data component 135 can include one or more records 137 storing training data, such as machine data 140 and damage data 145 that is generated, respectively by machine sensors 120 and damage sensors 115 associated with the test machine 110. The records 137 can also store environment (e.g., work site) data 150 associated with the training data. Such environment data can include an indication, or identifier, of the work site (e.g., a mine site), the date, the time, the elevation, the name of an operator of the test machine, etc. The records 137 can be organized or structured to preserve correlations between the machine data 140, the damage data 145, or the environment data 150 associated with each test machine 110. In some embodiments each of the records 137 can be associated with a different test machine 110. In some embodiments, the training data component 135 can automatically receive training data from the test machine 110, such as through a real time, periodic, or intermittent feed over a wireless communication channel.

The training component 155 can include a computing system or a software application configured to use the training data stored in train data repository 135 to train one or more predictive models 158 using one or more adaptive machine learning algorithms 157. In some embodiments, the training component 155 can receive training data from training data repository 135, and condition the training data, such as to sanitize or allocate the training data according a data structure or format specified for, or required by, the adaptive machine learning algorithms 157. The adaptive machine learning algorithms 157 can include implementations of one or more machine learning techniques. Such algorithms can include any machine learning technique configured to generate one or more predictive models (e.g., a predictive data structure) 158 to solve the multi-label classification problem of correlating the machine data generated by a machine, such as field machine 160, with predicted physical damage to one or more locations, or regions, of the frame of the machine. Such algorithms can include any machine learning algorithm configured to generate a predictive model 158 to solve the multi-class classification problem of classifying machine state data (hereinafter, “machine sensor data” or “machine data”) generated by a machine as physical damage to one or more specific region of the frame of the machine. The adaptive algorithms 157 can be used to generate a set of one or more predictive models 158 for use in correlating machine sensor data generated by a field machine 160 with predicted physical damage to one or more locations or regions of the frame of the field machine 160. Such algorithms can also include any other type of machine learning algorithm configured to implement the techniques described herein.

The adaptive algorithms 157 can be executed to adaptively train or learn the predictive models 158. Such adaptive execution can include the steps of providing a training data record 137 as input to an adaptive algorithm 157, receiving a predictive model 158 as output, testing or validating the predictive model, and repeating one or more of these steps until a desired validity metric is satisfied.

A predictive model 158 can include one or more data structures, tables, functions, filters (e.g., classifier), or other data object that are adaptively generated, such as by using machine learning, to correlate machine data to physical damage to a frame of a machine. A predictive model 158 can receive machine sensor data as input and generate a prediction of frame damage to a machine. In some embodiments, the predictive model 158 can also use environment data along with the machine sensor data to generate a damage prediction. Such environment data can, for example, be used to select a specific predictive model from a set of two or more predictive models 158 generated for a machine. Such environment data can be used to select or condition the machine sensor data before it is provided to predictive model 158.

The prediction component 159 can include one or more hardware or software components, such as for receiving field data from a field machine 160 and providing such field data to a predictive model 185 to generate a damage prediction 198. In some embodiments, the prediction component 159 can include a field machine 160, field data repository 170, and predictive model 185. The field machine 160 can include any off-highway machine or implement that is manufactured with one or more machine sensors 165 and one or more ECU 167, such as to capture and store the machine sensor data. The machine sensors 165 can generate data, such as machine data 175, indicative of the operating state of the field machine 160. The ECU 167 can capture the data generated by the machine sensors 165 and provide the captured data, such as in real time or at a delayed time, to one or more remote computing devices associated with the prediction component 159 as machine sensor data 175. Such remote computing devices can associate, and store, the provided machine sensor data 175 with environment data 180 in field data repository 170. The environment data 180 can include data indicative of the physical environment where the field machine 160 generated the machine sensor data 175.

The predictive model 185 can include one or more computing systems or software applications configured to select a predictive model 158 from the training system 105, such as by using a selection criteria derived from the environment data 180 and the field machine 160. Such computing systems or software applications can be further configured to execute the selected predictive model 185 using the machine sensor data 175 and the environment data 180 as inputs to generate a damage prediction 198.

The visualization system 187 can include one or more hardware or software components to receive data indicative of damage prediction 198 from the prediction component 159 and generate a graphical representation of predicted damage to the full frame of the field machine 160 (e.g., a production machine). Such predicted full frame damage can include predicted damage to the entire frame of a field machine 160. Such predicted full frame damage can also include predicted damage to one or more regions of the frame the field machine 160 for which damage data predicted by the predictive model 185 is not available. The graphical representation can be displayed on a graphical display terminal of the visualization system 187 and can include an image of the frame of the field machine 160, and one or more indicators showing predicted full frame damage. The one or more indicators can include any graphical object usable for indicating damage to the frame, such as a color gradient, selective shading or coloring, or one or more other graphical objects or symbols. The graphical representation can be generated by visualization component 190, which can include an event characterization component 195 and a visual model generator 197. The event characterization component 195 can receive the predicted damage data 198 and determine, such as by optimizing the fit of the predicted damage data to theoretical frame damage from one or more analytical models, one or more loading event parameters or coefficients for identifying loading events that are associated with the predicted damage generated by the predictive model 185. The visual model generator 197 can generate the graphical representation of the damage to the frame of the field system 160 by using the loading event parameters to select one or more pre-generated damage files, such as from a damage file repository, and combining the damage files in to a single graphical object. Such graphical object can be a data structure including a two-dimensional (2D) image, a three-dimensional image (3D), or a 2D or 3D animation. Each damage file can include a data structure, such as a file having a digital image of damage to the frame of the field machine 160 due to a specific loading event. Combining the damage files can include generating a single data structure including an overly of the image in each damage file, where a pixel in each such image is represented in the overlay with a color intensity or brightness determined, or weighted, based on the loading event parameters. Such intensity of brightness can be determined, or weighted, based on a frequency of the loading event or number of times a loading event corresponding to a damage file is experienced by the field machine 160.

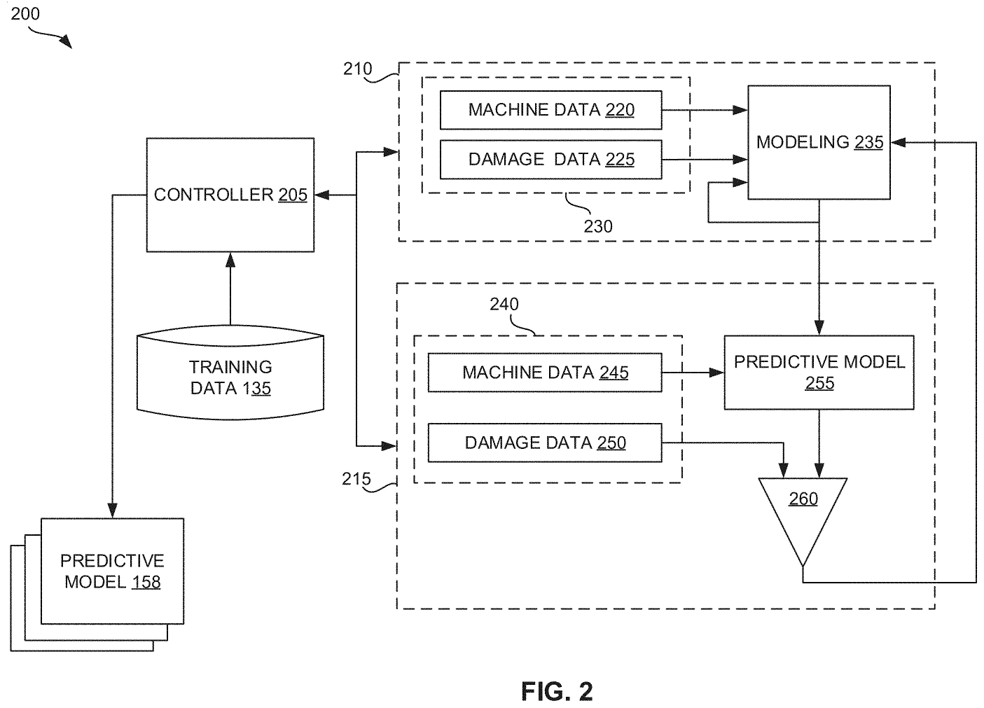

FIG. 2 illustrates a diagram of an example of a system 200 for using machine sensor data and machine learning to adaptively generate a damage prediction model 158 for visualizing frame damage, according to various embodiments. The system 200 can be an example of the training component 155 (FIG. 1), configured to generate one or more predictive models 158 using training data 135, as described herein. The system 200 can include controller 205, adaptive learning component 210, and validation component 215.

The controller 205 can include a computing device that is configured, such as with one or more software applications, to control the operation of learning component 210 and validation component 215, such as to generate the predictive models 158. The controller 205 can retrieve training data from training data repository 135 and condition the training data for use by learning component 210 and validation component 215. Such conditioning can include converting the training data to an appropriate format, scaling the training data, or filtering the training data. Such conditioning can also include partitioning the training data in to a training data set 230 and a validation data set 240. Such conditioning can further include allocating the training to appropriate data structures for processing using the learning component 210 and the validation component 215.

The learning component 210 can be configured with one or more machine learning algorithm or technique, such as implemented in one or more computing device or software applications, to adaptively train or learn a predictive model 255. The learning component 210 can receive training data set 230 from the controller 205 and iteratively provide training data from the training data set to the adaptive learning or modeling component (hereinafter, “modeling component”) 235 to generate the predictive model 255. In some embodiments, output of the modeling component 235 can be fed back to the input of the modeling component after each training cycle to advance the learning process. In some embodiments, the learning process can include adaptively training the predictive model 255 to correlate the machine data 220, such as data generated by machine sensors 120 (FIG. 1), with the damage data 225, such as data generated by damage sensors 115 (FIG. 1).

The validation component 215 can be configured, such as with one or more electronic circuits or software applications, to use validation dataset 240 to test or validate the predictive model 255. Such validation can include providing machine data 245 to the predictive model 255 to generate a damage prediction. The damage prediction can then be compared to damage data 250, such as by using analytical component 260. Analytical component 260 can be configured to compare the damage prediction generated by predictive model 255 to damage data 250 to generate one or more validation metric, such as distance or similarity score, that can be provided to the modeling component 235 or to the controller 205, such as to terminate or further advance the adaptive training process. At the end of the training process, the predictive model 255 can be added to a set of trained predictive models 158.

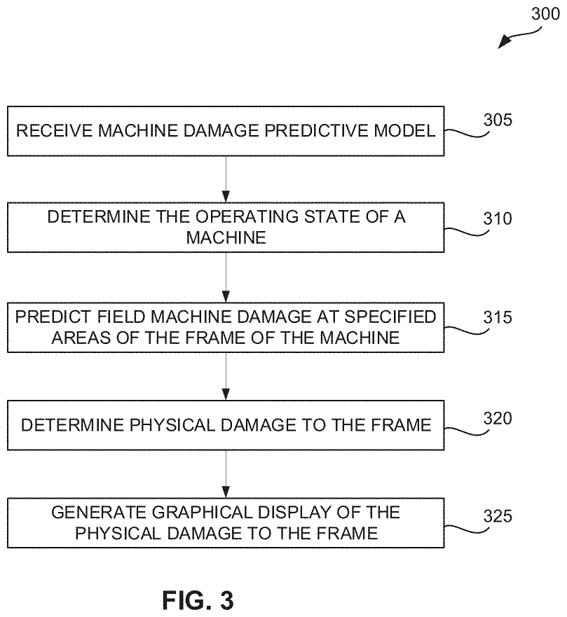

FIG. 3 illustrates an example of a process 300 for predicting machine frame damage using machine sensor data and machine learning, according to various embodiments. The process 300 can be implemented or executed by one or more computing devices configured with hardware or software components, such as the components of the system 100 (FIG. 1), to implement the operations and techniques described herein. Such software components can be embodied in a non-transitory machine-readable storage medium. Such non-transitory machine-readable storage medium can include any medium that is capable of storing, encoding, or carrying instructions for execution by a machine and that cause the machine to perform any one or more of the techniques of the present disclosure, or that is capable of storing, encoding or carrying data structures used by or associated with such instructions.

At 305, a machine damage predictive model (e.g., a predictive model) can be received, such as from the training component 155. At 310, the operating state of a machine can be determined. Such determining can include monitoring, or operating, one or more machine sensors on a field machine to generate machine sensor data that is indicative of the operating state of the field machine. Such determining can also include accessing and retrieving machine sensor data that is indicative of the operating state of a field machine, such as the field machine 160, or from a data repository. Such determining can also include retrieving environmental data associated with an environment in which the field machine is operated with generating the machine sensor data. At 315, the machine damage predictive model can be used with the determined machine operating state (e.g., the machine sensor data that is indicative of the machine operating state) to predict physical damage to a field machine. Such damage can include damage to one or more specified regions of the frame of a field machine, as described herein. At 320, physical damage to the entire frame of a field machine can be determined using predicted damage data and theoretical damage data generated by one or more analytical models, as described herein. In some embodiments, physical damage to one or more regions of the frame of a field machine can be determined using predicted damage data and theoretical damage data generated by one or more analytical models, as described herein. Such one or more regions can different from the locations of the field machine damage predicted at 315. At 325, a graphical display of the physical damage to the entire frame of a field machine can be generated. Such physical display can include an image of the frame of the field machine and damage indicators indicating the predicted physical damage to entire frame of the field machine, or to the one or more regions of the frame determined at 320.

Receiving the predictive model at 305 can include receiving, such as from a training data repository, machine sensor data indicative of an operating state one or more test machines, and physical damage data indicative of physical damage to one or more specified regions of one or more test machines. At least a portion of the machine sensor data can be captured contemporaneously with at least part of the physical damage data. A data structure comprising the predictive model can then be generated using the machine sensor data and the physical damage data, such as by adaptively adjusting parameters of the model to correlate the machine sensor data, or the operating state indicated by the machine sensor data, with the physical damage data or the physical damage indicated by the physical damage data.

Determining the physical damage to the entire frame of a field machine at 320 can include determining, using the theoretical damage data and predicted damage to the one or more specified locations of the field machine, one or more loading events associated with the predicted damage to the one or more specified locations of the field machine. The one or more loading events can then be mapped to damage models of the frame, where the damage models include one or more indicators indicating damage to the frame caused by a loading event. Such damage models can include indicators indicating damage to the frame caused by a loading event. Generating the graphical display at 325 can include combining, based on the one or more loading events, two or more of the damage models to form a combined, or overlaid, image of the frame.

The process 300 can further include configuring a system, such as a processor or a software application, to execute or implement the operations or techniques described herein.

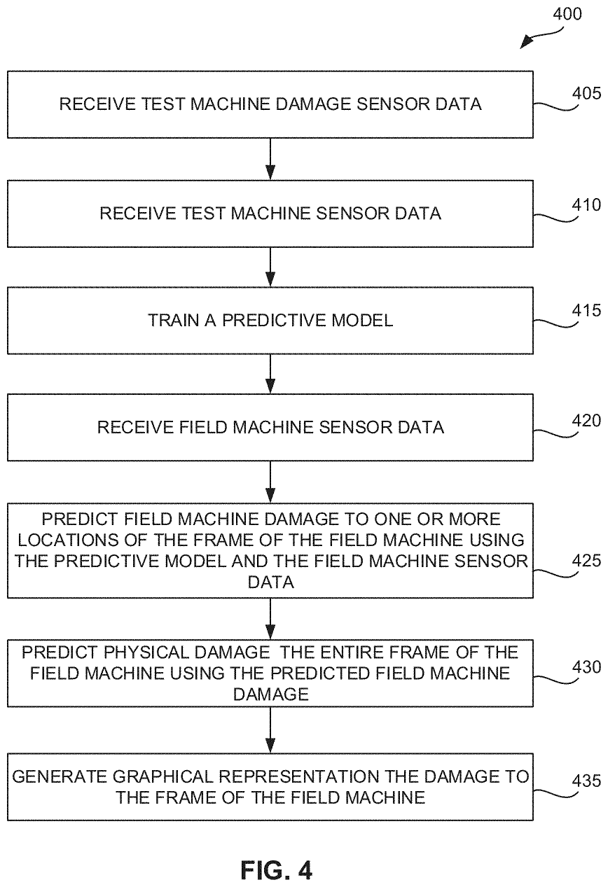

FIG. 4 illustrates an example of a process for visualizing frame damage predicted using machine sensor data and machine learning, according to various embodiments. The process 400 can be implemented or executed by one or more computing devices configured with hardware or software components, such as the components of the system 100 (FIG. 1), to implement the operations and techniques described herein. Such software components can be embodied in a non-transitory machine-readable storage medium, as described herein. At 405, machine sensor data can be received, such as from one or more testing systems 110 (FIG. 1). At 410, damage sensor data (e.g., damage data) can be received from one or more testing systems 110. Receiving the damage data and the machine sensor data can include accessing and retrieving such data, along with associated environmental data, from a training data repository, such as the training data repository 135 (FIG. 1). At 415, an adaptive model can be trained, such as by using one or more machine learning algorithms to adaptively generate a predictive model that correlates the received damage sensor data with the received machine sensor data. At 420, field machine sensor data can be received, such as from field machine 160 (FIG. 1). At 425, the predictive model generated at 415 can be used to predict field machine damage (e.g., physical damage), such as damage to one or more locations or regions of the frame of a field machine, as described herein. At 430, the predicted field machine damage can be used to predict physical damage to the entire frame of the field machine. At 435, a visual model of the damage to the entire frame of the field machine can be generated. Such graphical representation can include an image of the frame of the field machine along with one or more indicators to indicate the predicted damage to the frame or machine structure, as described herein.

The process 400 can further include configuring a system, such as a processor or a software application, to execute or implement the operations or techniques described herein.

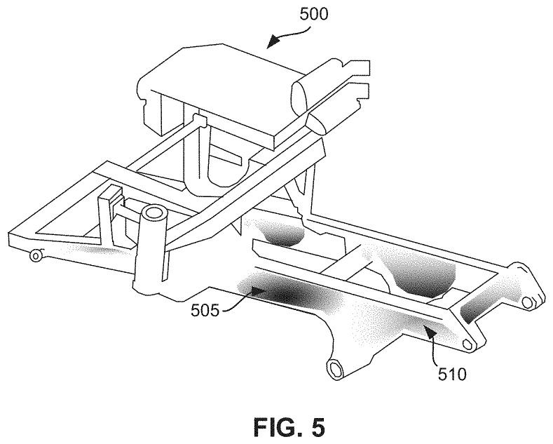

FIG. 5 illustrates an example of a graphical representation 500 of damage to a frame of a machine predicted using machine sensor data and machine learning, according to various embodiments. The graphical representation can be displayed on a graphical display terminal of a computing device associated with the systems described herein. The graphical representation can include an image of the frame 500 of a machine, such as an image of the frame of the field machine 160, and one or more indicators 505 or 515, showing predicted field damage to the frame of the machine.

### INDUSTRIAL APPLICABILITY

The techniques of the present disclosure use machine learning to predict and visualize damage to the frame or machine structure of a field machine (e.g., field vehicle) based on data generated from sensors that are commonly available of these production machines. These techniques thus enable the structural integrity of any, or all machines in a fleet to be electronically monitored in real time, or near real time, without having to install special sensors a or monitoring systems. Application of these techniques can provide a cost effect means for monitoring vehicles in a fleet, such as to provide early identification of potential problems to the frame of a field machine.

The techniques of the present disclosure can be used in fleet or field machines monitoring or diagnosis system for diagnosing the structural integrity of field machines using standard sensors provided on such field machines during their manufacture. Test machines that are specially configured or instrumented with damage sensors, such as strain gauges, can generate damage data indicating damage to the frame for a test machine in response to one or more loading events. The sensors are disposed about the frame of the test machine in such a way that the generated damage data can be used to identify a specific loading event that caused the damage to the frame. This data can be used together with contemporaneously captured field machine sensor data (e.g., data generated by standards sensors available on a field machine, such as speed and torque sensors) to adaptively train a predictive model to correlate this machine sensor data with the damage data. The predictive model can then be used to generate or predict damage data indicating damage to any field machine based on machine sensor data received from the field machine, thus eliminating the need for special instrumentation of the field machines. The predicted damage data can then be used to generate visual representations of damage to the entire frame of the field machine.

What is claimed is:

1. A system for characterizing frame damage to a field machine, the system comprising:
one or more processing circuits configured to:
receive first data indicative of an operating state of one or more test machines;
receive second data indicative of physical damage to first regions of the one or more test machines, at least part of the second data being captured contemporaneously with at least part of the first data;
generate, using the first data and the second data, a predictive data structure by iteratively correlating the operating state indicated by the first data with the physical damage indicated by the second data;
determine, based on one or more machine sensors, an operating state the field machine;
determine, using the predictive data structure and the operating state of the field machine, physical damage to at least one region of the field machine corresponding to at least one region of the first regions of the one or more test machines; and
generate, based on the physical damage to the at least one region of the field machine, a graphical display of the field machine, the graphical display comprising an image of the frame of the field machine and one or more indicators of theoretical damage to second regions of the field machine.

2. The system of claim 1, wherein the physical damage to the first regions correspond one or more loading events.

3. The system of claim 1, wherein the second data is received from one or more damage sensors that are disposed on the frame at regions that characterize loading events experienced by the one or more test machines.

4. The system of claim 1, wherein the predictive data structure is a model configured to predict physical damage to the field machine based on the operating state the field machine.

5. The system of claim 1, wherein to generate the graphical display, the one or more processing circuits are further configured to:
receive analytical data indicative of:
theoretical damage to one or more regions of the field machine, and
one or more loading events associated with the theoretical damage;
identify, based on the analytical data and the physical damage to the at least one region of the field machine, a loading event associated with the physical damage to the at least one region of the field machine, the loading event selected from the one or more loading events corresponding to the theoretical damage; and
map the loading event to one or more visual models of the field machine to generate the graphical display.

6. The system of claim 5, wherein to generate the graphical display, the one or more processing circuits are further configured to determine the indicators based on a frequency of the loading event.

7. The system of claim 1, wherein the at least one region of the field machine comprise at least one other region in addition to the first regions of the one or more test machines.

8. The system of claim 1, further comprising:
one or more machine sensors configured to measure operating parameters of the one or more test machines to generate the first data; and
one or more damage sensors configured to measure damage to the frame of the one or more test machines to generate the second data.

9. The system of claim 1, wherein the predictive data structure comprises at least one of a classifier, a filter, or a probabilistic function.

10. A method for visualizing damage to a frame of a field machine, the method comprising:
receiving a data structure configured to predict physical damage to regions of the frame based on data indicative of an operating state of the field machine;
determining, based on one or more machine sensors, the operating state of the field machine;
predicting, using the data structure and the operating state of the field machine, physical damage to one or more first regions of the frame;
determining, using theoretical damage data and the predicted physical damage to the one or more first regions of the frame, physical damage to other regions of the frame; and
generating a graphical display of the frame, the graphical display comprising an image of the frame and damage indicators indicating the physical damage to the other regions of the frame.

11. The method of claim 10, wherein receiving the data structure comprises:
receiving first data indicative of an operating state of one or more instrumented machines;
receiving second data indicative of physical damage to specified regions of the one or more instrumented machines, at least part of the second data being captured contemporaneously with at least part of the first data; and
generating, using the first data and the second data, the data structure by adaptively correlating the operating state of the one or more instrumented machines with the physical damage to the specified regions of the one or more instrumented machines.

12. The method of claim 11, wherein the second data is received from one or more damage sensors that are disposed on the frame at regions that characterize loading events experienced by the one or more instrumented machines.

13. The method of claim 11, wherein the data structure is a classifier configured to classify the first data as physical damage to at least one region of the field machine.

14. The method of claim 10, wherein determining physical damage to the other regions of the frame comprises:
determining, using the theoretical damage data and the predicted physical damage to the one or more first regions of the frame, one or more loading events associated with the predicted physical damage to the one or more first regions of the frame; and
mapping the one or more loading events to one or more damage models of the frame, the one or more damage models comprising at least one indicator indicating damage to the frame caused by a corresponding loading event.

15. The method of claim 14, wherein generating the graphical display of the frame comprises combining, based on the one or more loading events, two or more of the damage models to form image of the frame.

16. The method of claim 15 wherein combining, based on the one or more loading events, two or more of the damage models to form image of the frame, comprises:
weighting a color intensity of a graphical element in the damage models based a frequency at which the machine experiences the loading event.

17. A non-transitory machine-readable storage medium storing a set of instructions that, when executed by at least one processor of a machine, cause the machine to perform operations comprising:
receiving first data indicative of an operating state of one or more test machines;
receiving second data indicative of physical damage to first regions of the one or more test machines, at least part of the second data being captured contemporaneously with at least part of the first data;
generating, using the first data and the second data, a predictive data structure by iteratively correlating the first data with the second data;
determining, using one or more machine sensors, an operating state a field machine; and
determining, using the predictive data structure and the operating state of the field machine, physical damage to at least one region of the field machine, the at least one region of the field machine corresponding to at least one region of the first regions of the one or more test machines.

18. The non-transitory machine-readable storage medium of claim 17, wherein the operations further comprise:
generating, based on the physical damage to the at least one region of the frame of the field machine, a graphical display of the field machine, the graphical display comprising an image of the frame of the field machine and one or more indicators of theoretical damage to second regions of the field machine.

19. The non-transitory machine-readable storage medium of claim 18, wherein the damage data is received from one or more damage sensors that are disposed on the frame at regions that characterize loading events experienced by the one or more test machines.

20. The non-transitory machine-readable storage medium of claim 18, wherein the predictive data structure is a model configured to predict physical damage to the field machine in response to receiving the third data.
